(19) United States
(12) Patent Application Publication
(10) Pub. No.: US 2025/0078817 A1
(43) Pub. Date: Mar. 6, 2025

(54) System and Method for Dynamically Adjusting a Number of Emissions in Speech Processing Systems Operating with Large Stride Values

(71) Applicant: Microsoft Technology Licensing, LLC, Redmond, WA (US)

(72) Inventors: Nicola Ferri, Reading (GB); Felix Weninger, Wellesley, MA (US); Puming Zhan, Acton, MA (US)

(21) Appl. No.: 18/462,076

(22) Filed: Sep. 6, 2023

(51) Int. Cl. G10L 15/16; G10L 15/14

(52) U.S. Cl. CPC G10L 15/16; G10L 15/14

(57) ABSTRACT

A method, computer program product, and computing system for dynamically adjusting the number of emitted tokens per frame in speech processing systems operating with large stride values. The number of emitted tokens per frame can be dynamically adjusted in speech processing systems operating with large stride values by processing a signal frame according to a time-synchronous beam search technique at a frame rate based on a stride value; determining a hypothesis score for each hypothesis of a set of first information for the signal frame; determining a hypothesis score for each hypothesis of a set of second information for the signal frame; comparing a worst hypothesis score of the set of first information to a sum of a best hypothesis score of the set of second information and a threshold value; and ceasing processing of the signal frame when the worst hypothesis score of the set of first information is greater than the sum of the best hypothesis score of the set of second information and the threshold value.

### BACKGROUND

RNN Transducer (RNN-T) models are the most popular architecture for building online streaming automatic speech recognition (ASR) systems. As they are being deployed in production, reducing the inference complexity while preserving the accuracy helps to increase processing efficiency of ASR systems. Since the availability of graphics processing unit (GPU) devices for serving products is getting more and more limited with the prevalence of large language models, research is increasingly focused on inference with small batch sizes on central processing unit (CPU) devices.

The processing cost (e.g. computational complexity, time) of decoding RNN-T models using a time-synchronous beam search algorithm depends both on the length of the output of its encoder, and the maximum number of emissions per encoder output frame. In order to reduce the cost of decoding for ASR, it is possible to train RNN-T models that have a large stride factor (the ratio between input and output length) in the encoder, thus reducing the cost of decoding by shortening the encoder output length. Another way to reduce the decoding cost is to use an architecture that restricts the number of emissions, such as monotonic RNN-T, which limits the emissions per encoder output frame to one, thus putting a hard constraint on the second component. However, as the stride factor is increased beyond a certain point, monotonic RNN-T accuracy worsens sharply, because of the static restriction on the number of tokens that can be emitted per frame, which leads to outputs being omitted (deletion errors).

### BRIEF DESCRIPTION OF THE DRAWINGS

FIG. 1 is a flow chart of one implementation of the computational cost reduction process;

FIG. 2 is a diagrammatic view of a neural network in accordance with one implementation of the computational cost reduction process;

FIG. 3 is a graph showing a comparison of WER and RTF values in a system using static emissions and a system implementing dynamic emissions in accordance with one implementation of the computational cost reduction process; and

FIG. 4 is a diagrammatic view of a computer system and the computational cost reduction process coupled to a distributed computing network.

Like reference symbols in the various drawings indicate like elements.

### DETAILED DESCRIPTION

As will be discussed in greater detail below, implementations of the present disclosure allow the number of emissions (emitted tokens) per frame to be dynamically adjusted in speech processing systems operating with large stride values, which reduces the computational complexity and processing time of the ASR system. ASR systems operate by breaking down spoken language into smaller units for processing and analysis. A stride value is the reduction factor in an output of a layer of a machine learning model's neural network. For example, the stride value defines the factor by which an input will be reduced during processing by a subsequent layer of a machine learning model's neural network. As such, downsampling (reducing the size of) an input to a layer within a machine learning model's neural network can reduce computing costs. However, because less data is subsequently processed, downsampling can also lead to accuracy degradation. Accordingly, downsampling provides an effective trade-off between accuracy (where accuracy is generally measured in terms of word error rate (WER)) and speed (where speed is measured in terms of real-time factor (RTF)). When using an online streaming machine learning model, individual input sequences processed may vary over time and/or across online streaming machine learning models. As such, conventional approaches with fixed or predefined stride values are unable to account for varying sequence lengths or variations in machine learning models while balancing accuracy and speed. In some implementations of the disclosure, varying the stride value to accommodate processing signals of varying sequence lengths or data content facilitates optimization of the WER and RTF. In one example, a static stride value can be set to a large value based on testing data. In another example, a stride value can be automatically and dynamically set as large as possible based on a learning process, to optimize WER and RTF figures for the particular type of data being processed. The stride value can be dynamically set according to characteristics of data being processed. As will be discussed in greater detail below, downsampling may be performed using a large stride value.

When using an RNN Transducer (RNN-T) ASR model using a time-synchronous beam search algorithm, the computational cost of the decoding process depends both on the length of the output of the decoder and the maximum number of token emissions per encoder output frame. To reduce computational cost of decoding, RNN-T models can be trained using a large stride value in the encoder, to reduce the cost of decoding by shortening the encoder output length. In this way, information is compressed on the time axis progressively from the input to the output of the encoder. This results in less computation in the encoder and decoder because the decoder runs in a loop over the time dimension of the encoder. In other words, a high stride value results in a more compressed output of the encoder.

The computational cost can also be reduced by limiting the number of token emissions per encoder output frame, which reduces the processing time associated with the encoding process. A common model for limiting emissions is the monotonic RNN-T, which limits the emissions per encoder output frame to one. Therefore, only one token is emitted for each frame processed. However, as stride values are increased, the accuracy (WER) of the monotonic RNN-T model worsens. Accordingly, in order to reduce computational costs by using larger stride values, the number of emissions per encoder output frame is adjusted to provide a balance between reduced RTF values and increased WER values. Since increasing stride value results in a reduction of the encoder output length, a larger number of emissions per frame are processed to obtain satisfactory accuracy results. However, since the monotonic RNN-T model can only process one emission per frame, increasing emissions per frame is not possible, and the RNN-T model is not able to process inputs at higher stride values. However, setting a maximum number of emissions per frame is not ideal, since the desired accuracy could be obtained in fewer than a predetermined number of emissions and additional emissions could be processed that do not increase accuracy. Accordingly, dynamically limiting the number of emissions based on the likelihood or score of a hypothesis from further emitted tokens not improving the WER can be done to reduce RTF while arriving at an acceptable accuracy of the decoding process.

Some monotonic RNN-T models are operated with a stride value of 4, in which the typical frame rate of 10 ms is reduced by a factor of 4 resulting in a frame rate of 40 ms at the output (thus corresponding to a stride value of 4). Monotonic RNN-T models are able to operate at an acceptable accuracy (WER) using a stride value of up to 8 (i.e., an input frame rate of 10 ms and an output frame rate of 80 ms). However, since a monotonic RNN-T model only allows for the emission of a single token per frame, stride values higher than 8 will cause the accuracy of the model to degrade significantly.

The details of one or more implementations are set forth in the accompanying drawings and the description below. Other features and advantages will become apparent from the description, the drawings, and the claims.

### The Emission Adjusting Process:

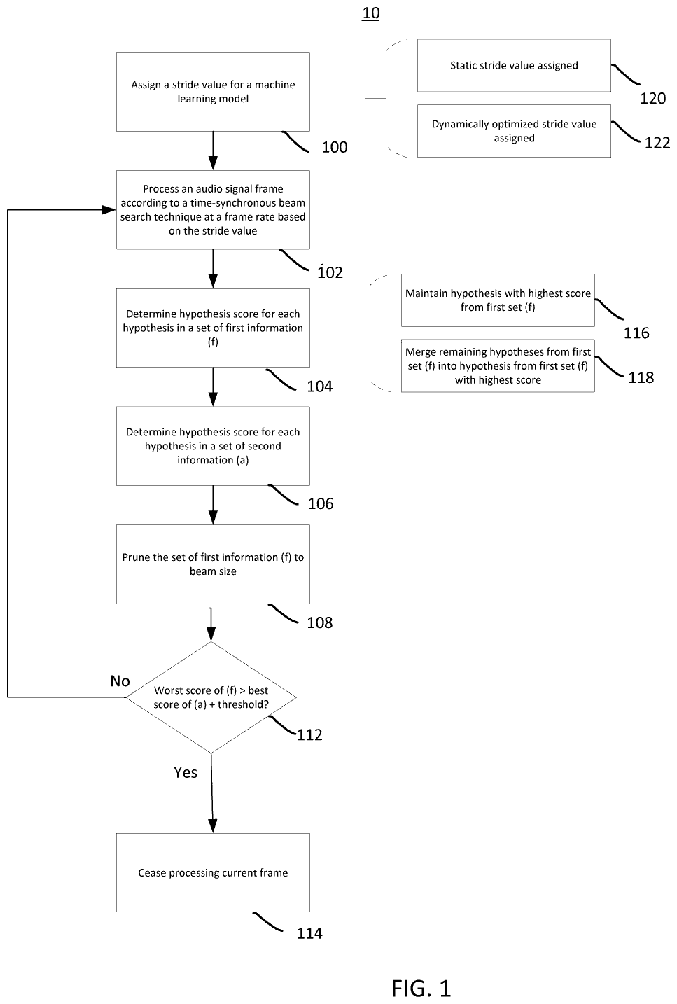

Referring to FIGS. 1-4, speech processing process 10 assigns 100 a stride value for a machine learning model. As described below, a static stride value based on testing data can be assigned, 120, or a dynamic optimized stride value can be assigned, 122. A frame of an encoded audio signal is processed 102, at a frame rate based on the stride value. In Automatic Speech Recognition (ASR), a hypothesis refers to a candidate transcription or interpretation of the spoken input that the ASR system generates during the decoding process. When processing audio input to convert spoken language into text, the ASR system generates multiple hypotheses representing possible transcriptions of the spoken content. The ASR system scores each hypothesis based on the likelihood of its occurrence according to the acoustic and language models. The hypothesis with the highest score is considered the most probable transcription at that step. A hypothesis score is determined for each hypothesis in a set of first information 104, a hypothesis score is determined for each hypothesis in a set of second information 106, and the set of first information is pruned to the beam size 108. If the worst hypothesis score of the set of first information is greater than the sum of the best hypothesis score of the set of second information and a threshold value 112, the processing for the current frame is ceased 114. If the worst hypothesis score of the set of first information is not greater than the sum of the best hypothesis score of the set of second information and the threshold value 112, the frame is continued to be processed according to tasks 102 to 108.

As discussed above, implementations of the present disclosure allow the number of emitted tokens per frame to be dynamically adjusted in speech processing systems operating with large stride values. A stride value is the reduction factor in an output of a layer of a machine learning model's neural network. For example, the stride value defines the factor by which an input will be reduced during processing by a subsequent layer of a machine learning model's neural network. In one example with automated speech recognition (ASR) models (e.g., Transformer and Conformer Transducers), the computing cost of the attention weights increases quadratically with increase in input sequence length. As such, downsampling an input to a layer within a machine learning model's neural network can reduce computing costs. However, downsampling can also lead to accuracy degradation. Accordingly, downsampling provides an effective trade-off between accuracy and speed.

As will be discussed in greater detail below, the number of emitted tokens per frame can be dynamically adjusted in speech processing systems operating with large stride values. by: (A) processing a signal frame according to a time-synchronous beam search technique at a frame rate based on a stride value; (B) determining a hypothesis score for each hypothesis of a set of first information for the signal frame; (C) determining a hypothesis score for each hypothesis of a set of second information for the signal frame; (D) comparing a worst hypothesis score of the set of first information to a sum of a best hypothesis score of the set of second information and a threshold value; and (E) ceasing processing of the signal frame when the worst hypothesis score of the set of first information is greater than the sum of the best hypothesis score of the set of second information and the threshold value. In one example, the processed signal frame is a representation of an audio signal. In another example, the processed signal frame is a frame of an encoded audio signal.

In one example, the stride value is greater than 8. In another example, the stride value is at least 12.

Typically, recurrent neural network transducer (RNN-T) models are used in ASR speech processing systems. A RNN-T model is composed of three components: the acoustic encoder that receives in input the speech segments to be recognized and generates a corresponding high-level representation; the prediction network that autoregressively incorporates previously emitted symbols into the model; and the joiner, that mixes both acoustic and autoregressive label representations via a monotonic alignment process.

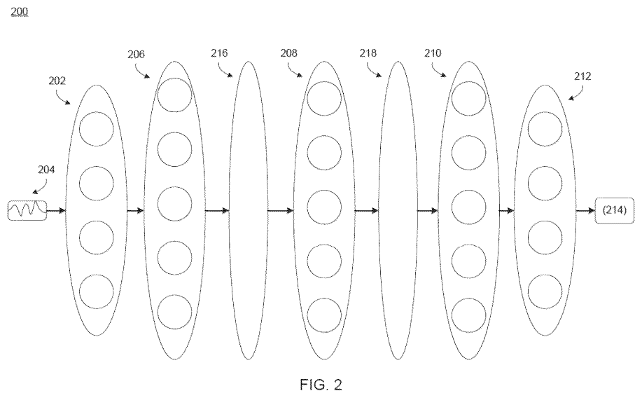

Referring also to FIG. 2, neural networks/artificial neural networks (e.g., neural network 200) include an input layer (e.g., input layer 202) that receives input data. In the example of speech processing, input layer 202 receives a speech signal (e.g., speech signal 204) in the time-domain. Neural network 200 includes a plurality of processing layers (e.g., layers 206, 208, 210) between the input layer (e.g., input layer 202) and an output layer (e.g., output layer 212). In some implementations, each layer (e.g., layers 206, 208, 210) is a mathematical function designed to produce an output specific to an intended result. In the example of an RNN-T model, neural network 200 includes an input layer (e.g., input layer 202), a MHSA layer (e.g., MHSA layer 206), a convolutional layer (e.g., convolutional layer 208), additional processing layer(s) (e.g., layer 210), and an output layer (e.g., output layer 212). MHSA layer 206 is a Multi Head Self Attention layer that allows neural network 200 to account for global context information with particular emphasis on past portions of the speech signal by focusing “attention” on more important portions of the speech signal and lessening “attention” on less important portions of the speech signal. Convolutional layer 208 allows neural network 200 to better model local correlations in the speech signal being processed. As will be discussed in greater detail below, neural network 200 is autoregressive model that uses attention mechanisms to generate enhanced predictions for speech processing. Neural network 200 is often referred to as a “Conformer”.

As described above, an RNN-T model trained with a large stride value is combined with an optimization of a beam search algorithm in order to reduce the cost of decoding. In some implementations, the optimization of the beam search algorithm includes dynamically adjusting the number of token emissions in the encoder to reduce the processing of tokens that do not increase the accuracy (or decrease the WER). Accordingly, this cost reduction is accomplished without a degradation in accuracy.

As described above, monotonic RNN-T models limit the number of token emissions to one per frame, which reduces the computational cost of processing audio signal information. Stride values used in monotonic RNN-T models can range from 2 to a maximum of 8. With stride values larger than 8, the accuracy of the monotonic RNN-T model breaks down, resulting in increased WER values.

Large stride RNN-T models, which can be obtained by training with spectral pooling, allow a progressive increase of the total stride by real-valued factors with minimal loss of accuracy. Since this results in a reduction of the encoder output length, the decoding process needs to explore a larger number of emissions per frame to obtain satisfactory results. However, while increasing the number of emissions can increase accuracy (reduce WER), unnecessary emissions that do not appreciably reduce WER may be executed, which increases RTF and ultimately, the computational cost of the process. Table 1 shows the effect of reducing the static number of emissions on WER (Word Error Rate) and RTF (Real Time Factor). In this example the RNN-T model was operated with a stride value of 13.7. Shown are the WER and RTF resulting from the operation of the model. As shown, reducing the number of emissions from 4 emissions to 1 increases WER. For an increase in the number of emissions beyond 4, the WER remains the same at 13.16%. Consequently, increasing the number of emissions increases RTF. Therefore, in a model trained with a static number of emissions, executing emissions beyond an efficient number can increase RTF without an associated decrease in WER.

TABLE 1

| Number of Emissions | WER (%) | RTF |
|---|---|---|
| 6 | 13.16 | 0.138 |
| 5 | 13.16 | 0.132 |
| 4 | 13.16 | 0.126 |
| 3 | 13.22 | 0.121 |
| 2 | 14.71 | 0.114 |
| 1 | 26.10 | 0.108 |

Implementations of the present disclosure allow the number of emissions to be dynamically adjusted to obtain optimum values of WER and RTF, thus reducing the average computation cost of the beam search decoding while maintaining acceptable accuracy. As discussed above, as tokens are emitted, scores for associated hypotheses are calculated and analyzed to provide a basis for determining the number of further tokens that will be emitted.

As discussed above, implementations of the present disclosure provide a determination of whether to process further emissions based on a comparison of scores of hypotheses for information processed by the model. According to the breadth-first decoding process, generated hypotheses are expanded together, which has the advantage of being able to batch the computations over all of the elements of the beam which is beneficial in both CPU and GPU systems due to memory locality. Starting with an empty Alive set and an empty Finished set in the model, for each frame in the output of the encoder, the probability of blank tokens and the probability of non-blank tokens is computed with the model. A Finished set is then defined as the Alive set concatenated with the blank token probabilities, in which each of the hypotheses in the Alive set is finished with a blank token. In this way, when a blank token is emitted in a given frame, the model can proceed to the next time frame.

A loop is then processed in which each of the hypotheses in the Alive set are expanded with the non-blank probabilities and pruned to the beam size. A new Finished set is created by expanding the Alive set with a blank token. The Finished set is then recombined with the new Finished set. This recombination is performed because, in the RNN-T model, a hypothesis produced in a previous frame may be equivalent a hypotheses being produced in the current frame. Equivalent in this implementation means that the non-blank tokens are the same, but the blank tokens are in different positions. When this occurs, the hypotheses that are equivalent are merged 118 and the hypothesis with the highest score is maintained 116. The Finished set is then pruned to the beam size. In a conventional system, this loop repeats until a fixed number of emissions is processed. This fixed number of emissions is always processed, even if additional emissions do not decrease the WER. This process has an adverse impact on RTF when non-productive emissions are processed.

As discussed above, implementations of the present disclosure provide a determination of whether to process further emissions based on a comparison of scores of hypotheses for information processed by the model. In one example, a cease condition is added to the process described above. This stop condition states that, if the worst hypothesis score in the Finished set is higher than the sum of the best hypothesis score in the alive set plus a predetermined threshold value, the process for that frame is ceased and the model moves on to process the next frame.

According to this condition, if the best score of the Alive hypothesis plus an arbitrary threshold value is not greater than the worst score in the Finished set, then it is unlikely that the Alive hypothesis, when closed with a blank token, will be merged into the finished set. At this point, further emissions will not contribute an appreciable reduction in WER, so further emissions will only increase the RTF without any accuracy improvement. In implementations of the present disclosure, the threshold value is an arbitrary number that is tuned to obtain the desired WER and RTF values for the system. In implementations of the present disclosure, the threshold value is a negative value, although positive values can be used with an appropriate adjustment in the cease condition. In other words, with a positive threshold value, the determination would be whether the best hypothesis score of the Alive set minus the threshold value is less than the worst score of the Finished set.

Examples of the effect of implementations of the present disclosure when operating the RNN-T model with a stride value of 13.7 are shown in Table 2 below. Each row in the table shows the effect of a different threshold value on the operation of the model, specifically WER, RTF, and the numbers of emissions per frame. Avg N is the average number of emissions per frame, columns N=<count> show which percentage of the total frames executed exactly <count> emissions. Note that percentages may not add up to exactly 100.00 due to rounding.

TABLE 2

| | WER | | N = 1 | N = 2 | N = 3 | N = 4 | N = 5 | |
|---|---|---|---|---|---|---|---|---|
| Threshold | (%) | Avg N | (%) | (%) | (%) | (%) | (%) | RTF |
| −0.5 | 13.16 | 1.88 | 34.91 | 49.08 | 9.42 | 6.11 | 0.48 | 0.114 |
| −1.0 | 13.15 | 1.77 | 40.86 | 45.72 | 8.87 | 4.19 | 0.35 | 0.114 |
| −1.5 | 13.17 | 1.67 | 46.69 | 42.48 | 7.90 | 2.67 | 0.27 | 0.114 |
| −2.0 | 13.20 | 1.60 | 51.78 | 39.28 | 6.79 | 1.94 | 0.21 | 0.113 |
| −2.5 | 13.25 | 1.53 | 56.53 | 35.96 | 5.83 | 1.52 | 0.17 | 0.112 |
| −3.0 | 13.34 | 1.47 | 60.62 | 33.02 | 4.97 | 1.25 | 0.14 | 0.112 |

As shown in Table 2, the use of each threshold value in the RNN-T operating according to the implementations of the present disclosure will yield specific WER and RTF rates. Further, by using this process with any of the shown threshold values, it can be seen that the average number of emissions is less than 2. Compared to the data in Table 2, the WER for the example in Table 1 where the number of emissions is 2 (WER=14.71) is much higher than any of the WERs in Table 2. Therefore, even though the implementation of the present disclosure will allow more than 2 emissions to occur (and, in some instances, more did occur), any additional emissions over 2 still resulted in WER improvement compared to the static emission model represented in Table 1. As described above, decreases in WER typically cause increases in RTF, because additional emissions that would improve accuracy and thus decrease WER, require additional processing time, which increases RTF. Likewise, decreasing RTF by reducing emissions will cause an increase in WER since less processing is done that would improve accuracy. As such, the relationship between WER and RTF is a tradeoff and the system is tuned to achieve WER and RTF figures that meet desired WER and RTF goals. Accordingly, an implementation of the present disclosure can produce several (WER, RTF) points such that WER <WER′ for all WER′ in the set of points {(WER′, RTF′) such that RTF′≤RTF} produced by the static system represented in Table 1 (WER′ and RTF′ being produced in the static system represented by Table 1).

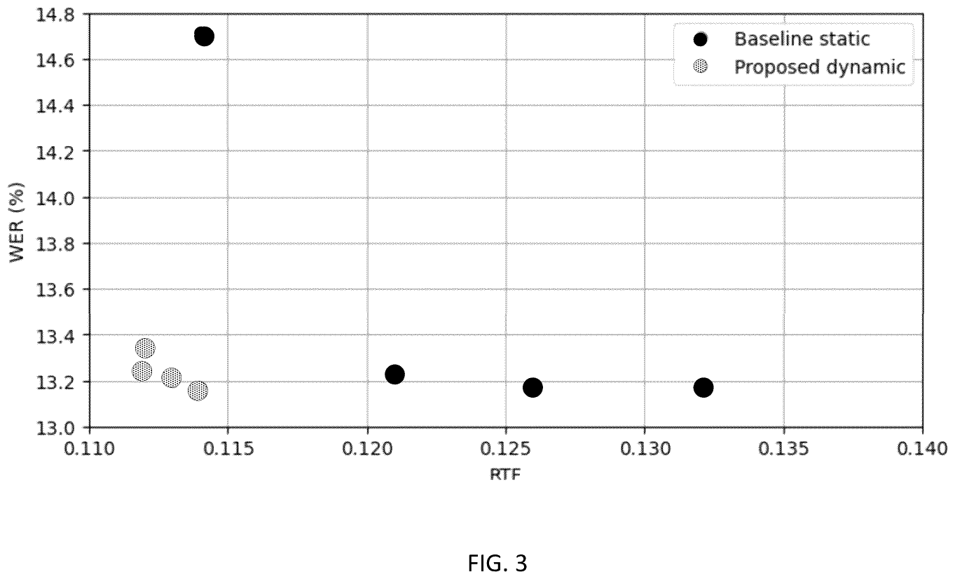

Referring now to FIG. 3, graphical representation of a comparison of WER and RTF values for the static emission model of Table 1 and the dynamic emission model of the implementation of the present disclosure and Table 2 is shown. In this example, computational cost reduction process 10 can reduce the RTF by 14% (from 0.132 to 0.114) without any degradation of recognition accuracy (WER=13.16 in both results), on top of a strong baseline using a high stride (13.7). While the maximum number of emissions in the system of Table 1 can be reduced to improve RTF, this results in a smaller RTF reduction and leads to a sharp WER increase when using less than 3 maximum token emissions per frame. Implementations of the present disclosure adapt the number of iterations for each utterance rather than setting a global limit. The large RTF gain is possible because the actual number of token emissions is small for most frames (it was 1.67 on average across the test set, in the setting that yielded RTF=0.114).

While the examples used in the description of the implementations were indicated as operating with a stride value of 13.7, the implementations according to the present disclosure will provide advantageous results when the RNN-T is operating at a stride value greater than 8 and preferably, at a stride value of at least 12.

### System Overview:

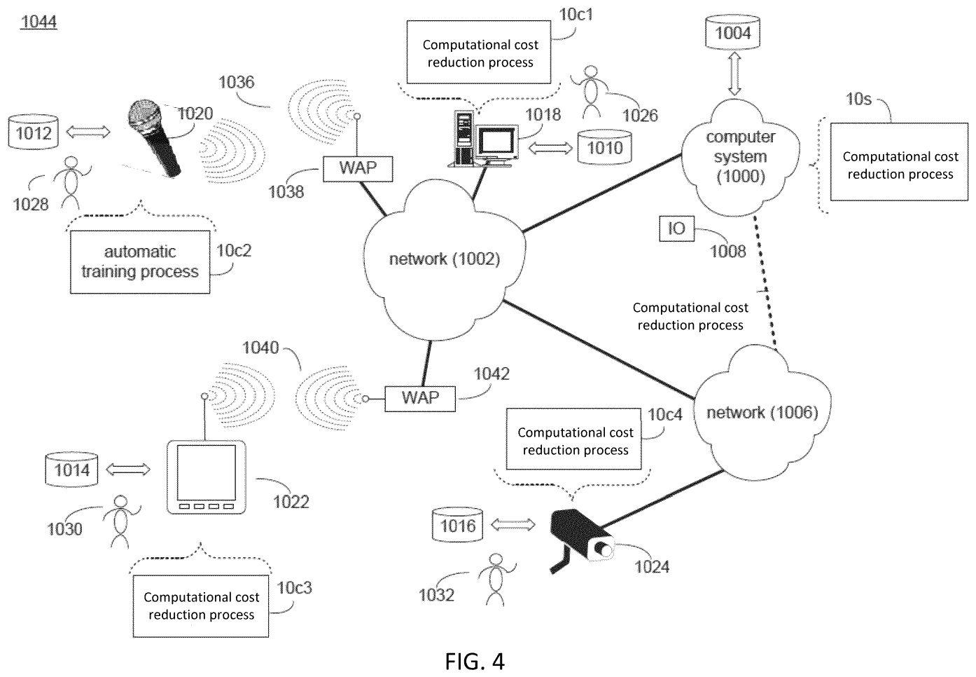

Referring to FIG. 4, there is shown computational cost reduction process 10. Computational cost reduction process 10 may be implemented as a server-side process, a client-side process, or a hybrid server-side/client-side process. For example, computational cost reduction process 10 may be implemented as a purely server-side process via computational cost reduction process 10s. Alternatively, computational cost reduction process 10 may be implemented as a purely client-side process via one or more of computational cost reduction process 10c1, computational cost reduction process 10c2, computational cost reduction process 10c3, and computational cost reduction process 10c4. Alternatively still, computational cost reduction process 10 may be implemented as a hybrid server-side/client-side process via computational cost reduction process 10s in combination with one or more of computational cost reduction process 10c1, computational cost reduction process 10c2, computational cost reduction process 10c3, and computational cost reduction process 10c4.

Accordingly, computational cost reduction process 10 as used in this disclosure may include any combination of computational cost reduction process 10s, computational cost reduction process 10c1, computational cost reduction process 10c2, computational cost reduction process 10c3, and computational cost reduction process 10c4.

Computational cost reduction process 10s may be a server application and may reside on and may be executed by a computer system 1000, which may be connected to network 1002 (e.g., the Internet or a local area network). Computer system 1000 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a minicomputer, a mainframe computer, a RAID device and a NAS system. The various components of computer system 1000 may execute one or more operating systems.

The instruction sets and subroutines of computational cost reduction process 10s, which may be stored on storage device 1004 coupled to computer system 1000, may be executed by one or more processors (not shown) and one or more memory architectures (not shown) included within computer system 1000. Examples of storage device 1004 may include but are not limited to: a hard disk drive; a RAID device; a random-access memory (RAM); a read-only memory (ROM); and all forms of flash memory storage devices.

Network 1002 may be connected to one or more secondary networks (e.g., network 1004), examples of which may include but are not limited to: a local area network; a wide area network; or an intranet, for example.

Various IO requests (e.g., IO request 1008) may be sent from computational cost reduction process 10s, computational cost reduction process 10c1, computational cost reduction process 10c2, computational cost reduction process 10c3 and/or computational cost reduction process 10c4 to computer system 1000. Examples of IO request 1008 may include but are not limited to data write requests (i.e., a request that content be written to computer system 1000) and data read requests (i.e., a request that content be read from computer system 1000).

The instruction sets and subroutines of computational cost reduction process 10c1, computational cost reduction process 10c2, computational cost reduction process 10c3 and/or computational cost reduction process 10c4, which may be stored on storage devices 1010, 1012, 1014, 1016 (respectively) coupled to client electronic devices 1018, 1020, 1022, 1024 (respectively), may be executed by one or more processors (not shown) and one or more memory architectures (not shown) incorporated into client electronic devices 1018, 1020, 1022, 1024 (respectively). Storage devices 1010, 1012, 1014, 1016 may include but are not limited to: hard disk drives; optical drives; RAID devices; random access memories (RAM); read-only memories (ROM), and all forms of flash memory storage devices. Examples of client electronic devices 1018, 1020, 1022, 1024 may include, but are not limited to, personal computing device 1018 (e.g., a smart phone, a personal digital assistant, a laptop computer, a notebook computer, and a desktop computer), audio input device 1020 (e.g., a handheld microphone, a lapel microphone, an embedded microphone (such as those embedded within eyeglasses, smart phones, tablet computers and/or watches) and an audio recording device), display device 1022 (e.g., a tablet computer, a computer monitor, and a smart television), a hybrid device (e.g., a single device that includes the functionality of one or more of the above-references devices; not shown), an audio rendering device (e.g., a speaker system, a headphone system, or an earbud system; not shown), and a dedicated network device (not shown).

Users 1026, 1028, 1030, 1032 may access computer system 1000 directly through network 1002 or through secondary network 1006. Further, computer system 1000 may be connected to network 1002 through secondary network 1006, as illustrated with link line 1034.

The various client electronic devices (e.g., client electronic devices 1018, 1020, 1022, 1024) may be directly or indirectly coupled to network 1002 (or network 1006). For example, personal computing device 1018 is shown directly coupled to network 1002 via a hardwired network connection. Further, machine vision input device 1024 is shown directly coupled to network 1006 via a hardwired network connection. Audio input device 1022 is shown wirelessly coupled to network 1002 via wireless communication channel 1036 established between audio input device 1020 and wireless access point (i.e., WAP) 1038, which is shown directly coupled to network 1002. WAP 1038 may be, for example, an IEEE 802.11a, 802.11b, 802.11g, 802.11n, Wi-Fi, and/or any device that is capable of establishing wireless communication channel 1036 between audio input device 1020 and WAP 1038. Display device 1022 is shown wirelessly coupled to network 1002 via wireless communication channel 1040 established between display device 1022 and WAP 1042, which is shown directly coupled to network 1002.

The various client electronic devices (e.g., client electronic devices 1018, 1020, 1022, 1024) may each execute an operating system, wherein the combination of the various client electronic devices (e.g., client electronic devices 1018, 1020, 1022, 1024) and computer system 1000 may form modular system 1044.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
(A) processing a signal frame according to a time-synchronous beam search technique at a frame rate based on a stride value;
(B) determining a hypothesis score for each hypothesis in a set of first information for the signal frame;
(C) determining a hypothesis score for each hypothesis in a set of second information for the signal frame;
(D) comparing a worst hypothesis score of the set of first information to a sum of a best hypothesis score of the set of second information and a threshold value; and
(E) ceasing processing of the signal frame when the worst hypothesis score of the set of first information is greater than the sum of the best hypothesis score of the set of second information and the threshold value.

2. The computer-implemented method of claim 1, further including repeating tasks (B) through (D) when the worst hypothesis score of the set of first information is not greater than the sum of the best hypothesis score of the set of second information and the threshold value.

3. The computer-implemented method of claim 1, wherein the stride value is greater than 8.

4. The computer-implemented method of claim 3, wherein the stride value is at least 12.

5. The computer-implemented method of claim 1, wherein the set of first information comprises information from the frame including a blank token.

6. The computer-implemented method of claim 1, wherein the set of second information comprises information from the frame including a non-blank token.

7. The computer-implemented method of claim 1 wherein the signal frame comprises a frame of an encoded audio signal.

8. The computer-implemented method of claim 1 wherein the stride value is dynamically set according to characteristics of data being processed.

9. A computing system comprising:
a memory; and
a processor to:
(A) process a frame of an encoded audio signal according to a time-synchronous beam search technique at a frame rate based on a stride value;
(B) determine a hypothesis score for each hypothesis in a set of first information for the frame of the encoded audio signal;
(C) determine a hypothesis score for each hypothesis in a set of second information for the frame of the encoded audio signal;
(D) compare a worst hypothesis score of the set of first information to a sum of a best hypothesis score of the set of second information and a threshold value;
(E) cease processing of the frame of the encoded audio signal when the worst hypothesis score of the set of first information is greater than the sum of the best hypothesis score of the set of second information and the threshold value; and
(F) repeating tasks (B) through (D) when the worst hypothesis score of the set of first information is not greater than the sum of the best hypothesis score of the set of second information and the threshold value.

10. The computing system of claim 9, wherein the stride value is greater than 8.

11. The computing system of claim 10, wherein the stride value is at least 12.

12. The computing system of claim 11, wherein the set of first information comprises information from the frame including a blank token.

13. The computing system of claim 12, wherein the set of second information comprises information from the frame including a non-blank token.

14. A computer program product residing on a non-transitory computer readable medium having a plurality of instructions stored thereon which, when executed by a processor, cause the processor to perform operations comprising:
(A) processing a frame of an encoded audio signal according to a time-synchronous beam search technique at a frame rate based on a stride value;
(B) determining a hypothesis score for each hypothesis in a set of first information for the frame of the encoded audio signal;
(C) determining a hypothesis score for each hypothesis in a set of second information for the frame of the encoded audio signal;
(D) comparing a worst hypothesis score of the set of first information to a sum of a best hypothesis score of the set of second information and a threshold value; and
(E) repeating tasks (B) through (D) when the worst hypothesis score of the set of first information is not greater than the sum of the best hypothesis score of the set of second information and the threshold value.

15. The computer program product of claim 14, further comprising ceasing processing of the audio signal frame when the worst hypothesis score of the set of first information is greater than the sum of the best hypothesis score of the set of second information and the threshold value.

16. The computer program product of claim 15, wherein the stride value is greater than 8.

17. The computer program product of claim 16, wherein the stride value is at least 12.

18. The computer program product of claim 17, wherein the set of first information comprises information from the frame including a blank token.

19. The computer program product of claim 18, wherein the set of second information comprises information from the frame including a non-blank token.

20. The computer-implemented method of claim 14 wherein the stride value is dynamically set according to characteristics of data being processed.
